(19) United States
(12) Patent Application Publication
(10) Pub. No.: US 2006/0089896 A1
(43) Pub. Date: Apr. 27, 2006

(54) Method and system for estimating valuation

(76) Inventors: Tobias Levkovich, Woodmere, NY (US); Evrard Fraise, New York, NY (US)

Correspondence Address: MILBANK, TWEED, HADLEY & MCCLOY, 1 CHASE MANHATTAN PLAZA, NEW YORK, NY, 10005-1413, US

(21) Appl. No.: 10/973,901

(22) Filed: Oct. 26, 2004

(51) Int. Cl. G06Q 40/00

(52) U.S. Cl. 705/37

(57) ABSTRACT

A method for valuation of the market, sectors of the market, industries in the market or companies, where price ratios of a predetermined group of securities representing the market, sector or industry are determined and debt adjusted ratios are determined by adjusting the price ratios using debt to capitalization ratios and a corporate bond yield index. The price ratios include price to earnings ratio, price to sales ratio and price to book ratio.

### BACKGROUND

The invention relates to the field of securities analysis and more particularly to the field of valuation.

To assist with investment decisions, investors use a number of market analysis tools which include market valuation models. A number of such market valuation models are known. Some of those models consider a subset of all securities, such as the companies in the Standard and Poor's 500 Index (S&P 500), as an indicator of value in the entire market. One valuation model that is believed to be used by the Federal Reserve is known as the “Fed model.” In a simple form, the Fed model takes the inverse of the market price to earnings ratio (P/E) of the S&P 500 and compares it with the 10-year T-bond yield. An example graphic plot of changes in market valuation over time using the Fed model is provided at FIG. 1. According to the Fed model, the market is more attractive when the valuation is below the average, and conversely, the market is more expensive when the valuation is above the average. The amount of deviation from the average is a relative indicator of how attractive or expensive the market is at a particular point in time. Since many investors make decisions based, in part, on such indicators, it is important to have market valuation techniques that are reliable.

The preceding description is not to be construed as an admission that any of the description is prior art relative to the present invention.

### SUMMARY OF THE INVENTION

In one embodiment, the invention provides a system and method for valuation. The system and method determine price ratios of a predetermined group of securities and determine debt adjusted ratios by adjusting the price ratios using debt to capitalization ratios and a corporate bond yield index.

In another embodiment, the invention provides a system and method for valuation that further comprises determining a time averaged value of the debt adjusted ratios and identifying statistical deviation of the debt adjusted ratios from the time averaged value as a valuation indicator.

In another embodiment, the invention provides a system and method for valuation that further comprises using the statistical deviation of debt adjusted ratios to identify valuation at different times.

In another embodiment, the invention provides a system and method for valuation that uses forward returns of a recognized index.

In another embodiment, the invention provides a system and method for valuation that divides price ratios by debt to capitalization ratios to produce a result and multiplies the result by a corporate bond index.

In another embodiment, the invention provides a system and method for valuation where the price ratios are price to earnings ratios.

In another embodiment, the invention provides a system and method for valuation where the price ratios are price to sales ratios.

In another embodiment, the invention provides a system and method for valuation where the price ratios are price to book ratios.

In another embodiment, the invention provides a system and method for valuation wherein the predetermined group of securities includes a generally recognized index of securities.

In another embodiment, the invention provides a system and method for valuation wherein the predetermined group of securities includes a sector of a generally recognized index of securities.

In another embodiment, the invention provides a system and method for valuation wherein the predetermined group of securities includes the Standard and Poor's 500 Index.

In another embodiment, the invention provides a system and method for valuation wherein the corporate bond yield index includes a Baa corporate bond yield index.

In another embodiment, the invention provides a system and method for valuation wherein the price ratios are trailing price ratios.

In another embodiment, the invention provides a system and method for valuation wherein the price ratios are forward price ratios.

The foregoing specific embodiments, objects and advantages of the invention are illustrative of those which can be achieved by the present invention and are not intended to be exhaustive or limiting of the possible advantages that can be realized. Thus, the embodiments, objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates a graphic plot of changes in market valuation over time using a known valuation model;

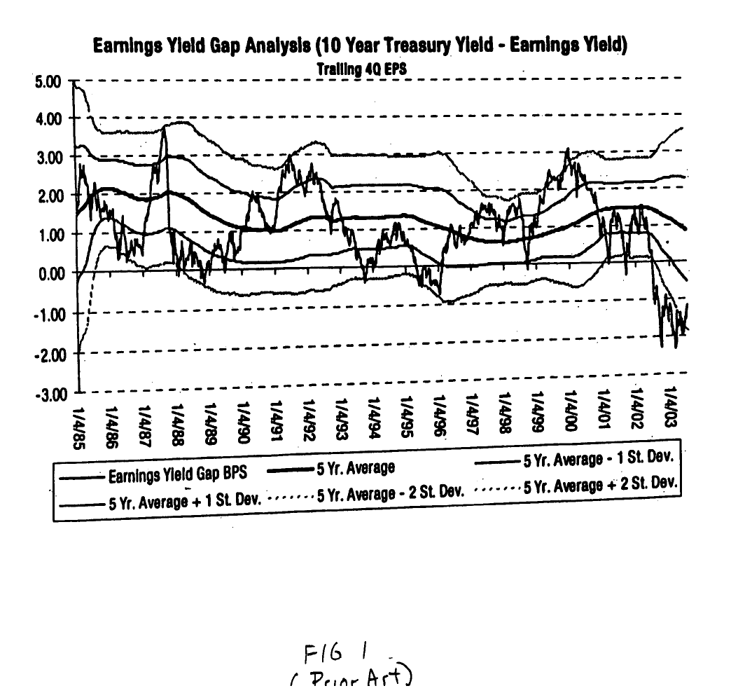

FIG. 2 illustrates an embodiment of a system according to the invention;

FIG. 3 illustrates steps in an embodiment of a method according to the invention;

FIG. 4 illustrates a graphic plot of changes in market valuation over time using an embodiment of the invention; and

FIG. 5 illustrates steps in an embodiment of a method according to the invention.

It is understood that the drawings are for illustration only and are not limiting.

### DETAILED DESCRIPTION OF THE DRAWINGS

In various embodiments, the invention considers traditional price to earnings valuation, price to sales valuation, or price to book valuation, but also considers the cost of debt and amount of debt in the market, providing greater insight into valuation of the market.

In certain embodiments, the invention provides an indication of valuation for the entire market, sectors of the market, industries in the market, and even individual companies.

Example System

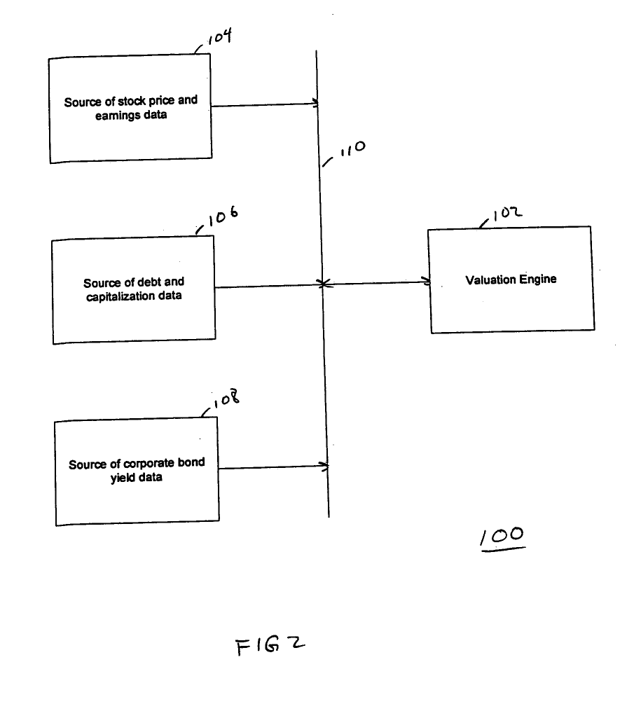

Referring to FIG. 2, an example embodiment of system 100 includes a valuation engine 102 connected to a communications medium 110 that permits communication to a source of stock price and earnings data 104, a source of debt and capitalization data 106, and a source of corporate bond yield data 108. Valuation engine 102 is typically a computer, with a CPU, RAM and ROM memory, I/O and non-volatile data storage, such as a hard disk. The communications medium 110 may be a wired, or wireless connection such as a network interface, modem, or other form of I/O, and could be replaced by a manual transfer of data. Sources 104, 106, 108 are typically databases, and although they are illustrated as separate from each other and from engine 102, one or more may be part of a combined database. Further, they may be part of or stored in the memory of engine 102.

Example Methods

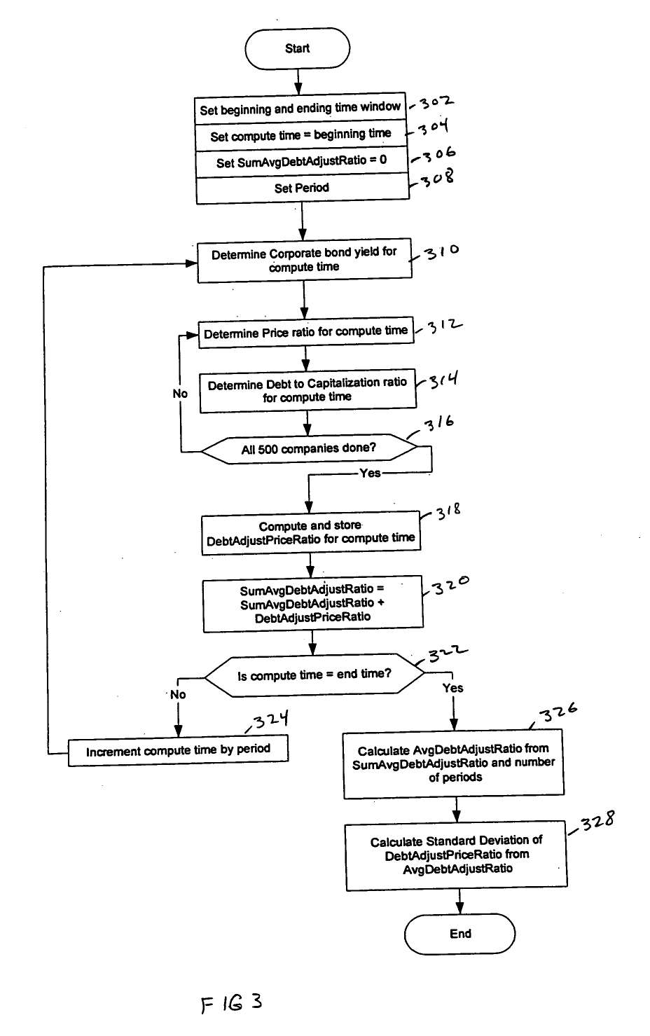

Referring to FIG. 3, a method for estimating the valuation of the stocks in the S&P 500 Index is shown. The method begins at step 302 with the operator setting a beginning and ending time window in the valuation engine of system 100. The beginning time is often a number of years in the past, or it may be the earliest date with reliable or acceptable information.

At step 304, system 100 sets a compute time equal to the beginning time. This allows compute time to be used as a loop counter.

At step 306, system 100 initializes the sum of the average debt adjusted ratio to zero.

At step 308, the operator of system 100 sets the desired period. The period is used as a step interval. It will also determine the data required within the calculation loop, e.g., daily, weekly, monthly, quarterly or yearly data.

Once the operator and system have established the initial parameters for the valuation model, then at step 310 valuation engine 102 of system 100 determines the corporate bond yield at compute time. This step is the beginning of a loop. There are a number of sources for corporate bond yield information, such as Moody's. In one embodiment, the invention uses the Baa corporate bond yield. Use of this bond rating helps to average the difference between companies with different bond ratings. In other embodiments, the invention uses other corporate bond yields.

At step 312, valuation engine 102 of system 100 determines the price ratio at compute time of a first company in the S&P500 Index from the source of stock price data 104. This is the beginning of a second loop. Although source 104 is illustrated as having price and earnings data, other price ratios may be used. Thus, examples of price ratios are: price to earnings ratio; price to sales ratio; and price to book ratio. Each of these ratios use a stock trading price divided by earnings, sales or book value, respectively. The price is generally the stock price taken at a consistent point in time, such as the closing price of the last trade for the day.

The values in the denominator of the ratio (e.g., earnings, sales and book) may be actual or reported values (often referred to as trailing values). Alternatively, the values in the denominator may be projected values (often referred to as forward values).

At step 314, valuation engine 102 of system 100 determines the debt to capitalization ratio at compute time of the current company in the S&P 500 Index from source of debt and capitalization data 106. This type of data is available from a number of different sources, some of which include FactSet and First Call.

At step 316, valuation engine 102 of system 100 determines whether price ratio information and debt and capitalization information for all of the companies in the S&P 500 Index has been determined for compute time. If not, valuation engine 102 loops to step 312 to get the information for the next company in the Index.

When price ratio information and debt and capitalization information for all of the companies in the S&P 500 at compute time is determined, then at step 318, valuation engine 102 of system 100 calculates or computes the debt adjusted price ratio for compute time, and saves the information.

In one embodiment, the debt adjusted price ratio is a debt adjusted price to earnings value (DATPE), which is calculated according to:

$$DATPE = \frac{\frac{P}{E}}{\frac{D}{C}} * Indexed\_BaaYield$$

where, P is the stock price, E is the earnings price, D is the debt, C is the capitalization, and the Indexed_BaaYield is the investment grade corporate bond yield, indexed over time.

In another embodiment, the debt adjusted price ratio is a debt adjusted price to sales value (DATPS), which is calculated according to:

$$DATPS = \frac{\frac{P}{S}}{\frac{D}{C}} * Indexed\_BaaYield$$

where, P is the stock price, S is the sales price, D is the debt, C is the capitalization, and BaaYield is the corporate bond yield.

In another embodiment, the debt adjusted price ratio is a debt adjusted price to book value (DATPB), which is calculated according to:

$$DATPB = \frac{\frac{P}{B}}{\frac{D}{C}} * Indexed\_BaaYield$$

where, P is the stock price, B is the book price, D is the debt, C is the capitalization, and BaaYield is the corporate bond yield.

At step 320, valuation engine 102 of system 100 adds the debt adjusted price ratio to the sum of the average debt adjusted ratio.

At step 322, valuation engine 102 of system 100 determines whether compute time is equal to end time. If not, then at step 324 valuation engine 102 increments compute time by one period and loops to step 310 to determine the corporate bond yield for the new compute time. This loop continues until compute time reaches end time.

When valuation engine 102 of system 100 determines at step 322 that compute time has reached end time, then at step 326 valuation engine 102 calculates the average debt adjusted ratio by dividing the sum of the average debt adjusted ratio by the number of periods.

At step 328, valuation engine 102 of system 100 calculates the standard deviation of the debt adjusted price ratios at each compute time.

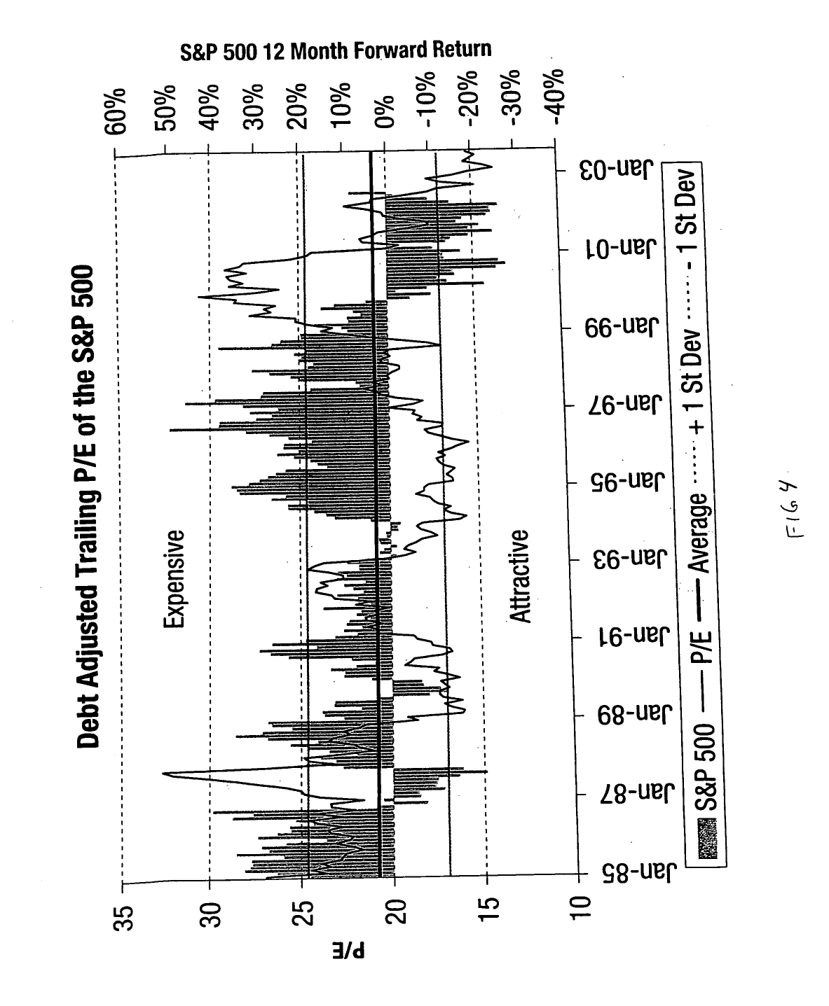

After the standard deviation is calculated, valuation engine 102 plots the average debt adjusted ratio, the debt adjusted price ratio at each compute time and the standard deviation. An example of such a plot is provided at FIG. 4.

As illustrated in FIG. 4, the debt adjusted price ratio (here the price to earnings ratio) is plotted in a solid line. The scale for this plot is on the left side of the figure. The average debt adjusted price ratio is plotted in a heavier horizontal line, and reflects the average value over the period illustrated in the figure. Above and below the average value of the debt adjusted price ratio are broken lines indicating one standard deviation above the average and one standard deviation below the average value. As illustrated, when the debt adjusted price ratio is above the average, the market valuation may be considered mildly expensive and particularly expensive when the debt adjusted price ratio is more than one standard deviation above the average. Conversely, when the debt adjusted price ratio is below the average, the market valuation may be considered mildly attractive and particularly attractive when the debt adjusted price ratio is more than one standard deviation below the average.

Also plotted on FIG. 4 is the 12 month forward return on the S&P 500 Index. The forward return at different points in time is illustrated by vertical bars, with the scale on the right side of the figure. In this manner, it is possible to consider two different metrics and their relationships on the same figure.

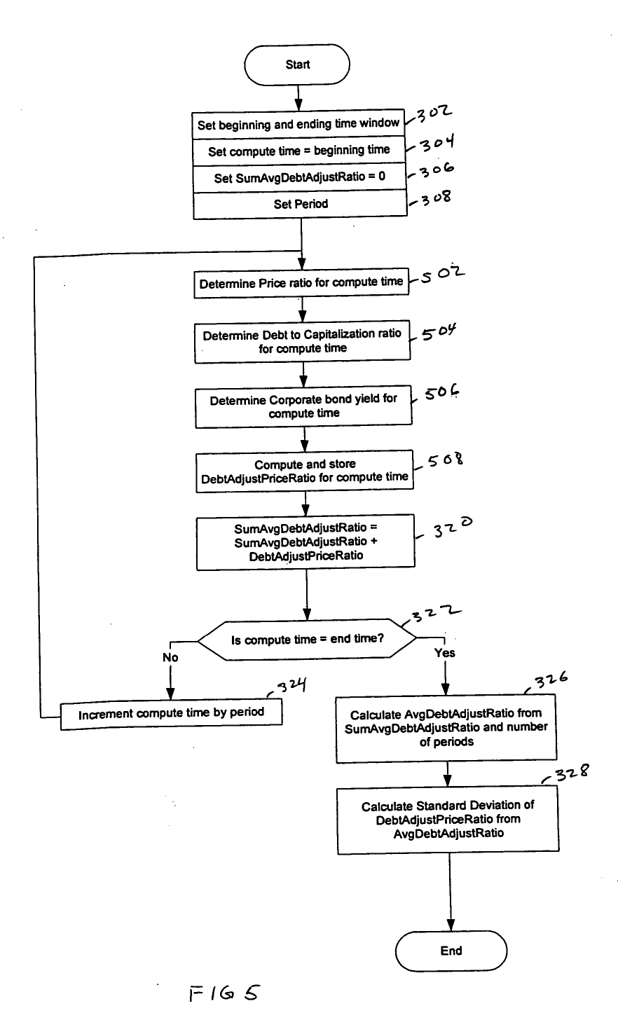

As described above, FIG. 3 illustrates steps in one embodiment for calculating debt adjusted price ratios. FIG. 5 illustrates another embodiment for calculating debt adjusted price ratios. In FIG. 5, steps 302 through 308 are the same as illustrated in FIG. 3 and described above.

At step 502, valuation engine 102 of system 100 determines a price ratio for compute time. In this embodiment, the price ratio is the ratio for the entire market, such as the price ratio for the S&P 500.

At step 504, valuation engine 102 of system 100 determines a debt to capitalization ratio for compute time. Again, in this embodiment, the debt to capitalization ratio is the ratio for the entire market, such as the debt to capitalization ratio for the S&P 500.

At step 506, valuation engine 102 of system 100 determines the corporate bond yield for compute time.

At step 508, valuation engine 102 of system 100 uses the price ratio, debt to capitalization ratio and the corporate bond yield to calculate and store a debt adjusted price ratio at compute time for the entire market (e.g., the S&P 500).

Remaining steps 320 through 328 in FIG. 5 are the same as those steps in FIG. 3.

In the descriptions above, market valuation is calculated using the S&P 500 Index. It is also possible to calculate valuation of an industry or sector by using a group of companies to represent the industry or sector, in the same way that the companies in the S&P 500 represent the entire market. It is also possible to apply the invention to an individual company or a small group of companies.

Although illustrative embodiments have been described herein in detail, it should be noted and will be appreciated by those skilled in the art that numerous variations may be made within the scope of this invention without departing from the principles of this invention and without sacrificing its chief advantages. In particular, although an example embodiment of a system is illustrated in FIG. 2, a person of ordinary skill in the art will know that many other systems and configurations are suitable and equivalent. Also, example embodiments of methods are illustrated in FIGS. 3 and 5. However, a person of ordinary skill in the art will know that many of the illustrated steps are interchangeable and can be performed in other orders, with additional steps added, or with some steps omitted.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

We claim:

1. A method for valuation of a group of securities, the method comprising:
determining historic trailing price ratios associated with a predetermined group of securities;
determining debt adjusted ratios by:
dividing the historic trailing price ratios by debt to capitalization ratios associated with the predetermined group of securities to produce a result; and
multiplying the result by values of a corporate bond yield index;
determining a time averaged value of the debt adjusted ratios; and
identifying statistical deviation of the debt adjusted ratios from the time averaged value as a valuation indicator.

2. A method according to claim 1, further comprising:
using the statistical deviation of the debt adjusted ratios to identify valuations at different times.

3. A method according to claim 2, wherein the statistical deviation is one standard deviation above or below the time averaged value.

4. A method according to claim 1, wherein the price ratios comprise a plurality of price ratios, each of which ratio represents the ratio of the entire predetermined group of securities.

5. A method according to claim 1, wherein the price ratios comprise a plurality of price ratios, each of which ratio represents the ratio of a single security in the predetermined group of securities.

6. A method according to claim 1, further comprising:
comparing the debt adjusted ratios with a forward return of a recognized index.

7. A method according to claim 1, wherein the price ratios are price to earnings ratios.

8. A method according to claim 1, wherein the price ratios are price to sales ratios.

9. A method according to claim 1, wherein the price ratios are price to book ratios.

10. A method according to claim 1, wherein the predetermined group of securities includes a generally recognized index of securities.

11. A method according to claim 1, wherein the predetermined group of securities includes a sector of a generally recognized index of securities.

12. A method according to claim 1, wherein the predetermined group of securities includes the Standard and Poor's 500 Index.

13. A method according to claim 1, wherein the predetermined group of securities includes an industry sector of the Standard and Poor's 500 Index.

14. A method according to claim 1, wherein the corporate bond yield index is a Baa corporate bond yield index.

15. A method for valuation of a group of securities, the method comprising:
determining historic forward price ratios associated with a predetermined group of securities;
determining debt adjusted ratios by:
dividing the historic forward price ratios by debt to capitalization ratios associated with the predetermined group of securities to produce a result; and
multiplying the result by values of a corporate bond yield index;
determining a time averaged value of the debt adjusted ratios; and
identifying statistical deviation of the debt adjusted ratios from the time averaged value as a valuation indicator.

16. A method for valuation of a group of securities, the method comprising:
determining historic trailing price to earnings ratios associated with securities in the Standard & Poor's 500 Index;
determining debt adjusted price to earnings ratios by:
dividing the historic price to earnings ratios by debt to capitalization ratios associated with the securities in the Standard & Poor's 500 index to produce a result; and
multiplying the result by values of a corporate bond yield index;
determining a time averaged value of the debt adjusted price to earnings ratios; and
identifying standard statistical deviation of the debt adjusted ratios from the time averaged value as a market valuation indicator.

17. A system for valuation of a group of securities, the system comprising:
means for determining historic trailing price ratios associated with a predetermined group of securities;
means for determining debt adjusted ratios by:
dividing the historic trailing price ratios by debt to capitalization ratios associated with the predetermined group of securities to produce a result; and
multiplying the result by values of a corporate bond yield index;
means for determining a time averaged value of the debt adjusted ratios; and
means for identifying statistical deviation of the debt adjusted ratios from the time averaged value as a valuation indicator.

18. A system for valuation of a group of securities, the system comprising:
means for determining historic trailing price to earnings ratios associated with securities in the Standard & Poor's 500 Index;
means for determining debt adjusted price to earnings ratios by:
dividing the historic price to earnings ratios by debt to capitalization ratios associated with the securities in the Standard & Poor's 500 Index to produce a result; and
multiplying the result by values of a corporate bond yield index;
means for determining a time averaged value of the debt adjusted price to earnings ratios; and
means for identifying standard statistical deviation of the debt adjusted ratios from the time averaged value as a market valuation indicator.

19. A system for valuation of a group of securities, the system comprising:
a source of debt to capitalization ratio information;
a source of corporate bond yield index information; and
a valuation engine configured to receive information from the source of debt to capitalization ratio information and the source of corporate bond yield index information, wherein the valuation engine is further configured to:
determine historic trailing price ratios associated with a predetermined group of securities;
determine debt adjusted ratios by:
dividing the historic trailing price ratios by debt to capitalization ratios associated with the predetermined group of securities to produce a result; and
multiplying the result by values of a corporate bond yield index;
determine a time averaged value of the debt adjusted ratios; and
identify statistical deviation of the debt adjusted ratios from the time averaged value as a valuation indicator.

20. A system for valuation of a group of securities, the system comprising:
a source of debt to capitalization ratio information;
a source of corporate bond yield index information; and
a valuation engine configured to receive information from the source of debt to capitalization ratio information and the source of corporate bond yield index information, wherein the valuation engine is further configured to:
determine historic trailing price to earnings ratios associated with securities in the Standard & Poor's 500 Index;
determine debt adjusted price to earnings ratios by:
dividing the historic price to earnings ratios by the debt to capitalization ratios associated with the securities in the Standard & Poor's 500 Index to produce a result; and
multiplying the result by values of the corporate bond yield index;
determine a time averaged value of the debt adjusted price to earnings ratio; and
identify standard statistical deviation of the debt adjusted ratios from the time averaged value as a market valuation indicator.

21. Computer executable software code transmitted as an information signal, the code for valuation of a group of securities, the code comprising:
code to determine historic trailing price ratios associated with a predetermined group of securities;
code to determine debt adjusted ratios by:
dividing the historic trailing price ratios by debt to capitalization ratios associated with the predetermined group of securities to produce a result; and
multiplying the result by values of a corporate bond yield index;
code to determine a time averaged value of the debt adjusted ratios; and
code to identify statistical deviation of the debt adjusted ratios from the time averaged value as a valuation indicator.

22. Computer executable software code transmitted as an information signal, the code for valuation of a group of securities, the code comprising:
code to determine historic trailing price to earnings ratios associated with securities in the Standard & Poor's 500 Index;
code to determine debt adjusted price to earnings ratios by:
dividing the historic price to earnings ratios by debt to capitalization ratios associated with the securities in the Standard & Poor's 500 Index to produce a result; and
multiplying the result by values of a corporate bond yield index;
code to determine a time averaged value of the debt adjusted price to earnings ratios; and
code to identify standard statistical deviation of the debt adjusted ratios from the time averaged value as a market valuation indicator.

23. A computer-readable medium having computer executable software code stored thereon, the code for valuation of a group of securities, the code comprising:
code to determine historic trailing price ratios associated with a predetermined group of securities;
code to determine debt adjusted ratios by:
dividing the historic trailing price ratios by debt to capitalization ratios associated with the predetermined group of securities to produce a result; and
multiplying the result by values of a corporate bond yield index;
code to determine a time averaged value of the debt adjusted ratios; and
code to identify statistical deviation of the debt adjusted ratios from the time averaged value as a valuation indicator.

24. A computer-readable medium having computer executable software code stored thereon, the code for valuation of a group of securities, the code comprising:
code to determine historic trailing price to earnings ratios associated with securities in the Standard & Poor's 500 Index;
code to determine debt adjusted price to earnings ratios by:
dividing the historic price to earnings ratios by debt to capitalization ratios associated with the securities in the Standard & Poor's 500 Index to produce a result; and
multiplying the result by values of a corporate bond yield index;
code to determine a time averaged value of the debt adjusted price to earnings ratios; and
code to identify standard statistical deviation of the debt adjusted ratios from the time averaged value as a market valuation indicator.

25. A programmed computer for valuation of a group of securities, comprising:
a memory having at least one region for storing computer executable program code; and
a processor for executing the program code stored in the memory, wherein the program code comprises:
code to determine historic trailing price ratios associated with a predetermined group of securities;
code to determine debt adjusted ratios by:
dividing the historic trailing price ratios by debt to capitalization ratios associated with the predetermined group of securities to produce a result; and
multiplying the result by values of a corporate bond yield index;
code to determine a time averaged value of the debt adjusted ratios; and
code to identify statistical deviation of the debt adjusted ratios from the time averaged value as a valuation indicator.

26. A programmed computer for valuation of a group of securities, comprising:
a memory having at least one region for storing computer executable program code; and
a processor for executing the program code stored in the memory, wherein the program code comprises:
code to determine historic trailing price to earnings ratios associated with securities in the Standard & Poor's 500 Index;
code to determine debt adjusted price to earnings ratios by:
dividing the historic price to earnings ratios by debt to capitalization ratios associated with the securities in the Standard & Poor's 500 Index to produce a result; and
multiplying the result by values of a corporate bond yield index;
code to determine a time averaged value of the debt adjusted price to earnings ratios; and
code to identify standard statistical deviation of the debt adjusted ratios from the time averaged value as a market valuation indicator.
